(19) United States
(12) Patent Application Publication
(10) Pub. No.: US 2026/0301217 A1
(43) Pub. Date: Oct. 1, 2026

(54) SYSTEM, PROCESSING DEVICE, METHOD OF SYSTEM, METHOD OF PROCESSING DEVICE, AND STORAGE MEDIUM

(71) Applicant: CANON KABUSHIKI KAISHA, Tokyo (JP)

(72) Inventors: ASUKA MATSUOKA, Kanagawa (JP); TSUYOSHI OYA, Kanagawa (JP)

(21) Appl. No.: 19/547,044

(22) Filed: Feb. 23, 2026

(30) Foreign Application Priority Data
Mar. 26, 2025 (JP) 2025-051212

(51) Int. Cl. G06T 7/73; G06T 7/292; H04N 23/611; H04N 23/695

(52) U.S. Cl. CPC G06T 7/73; G06T 7/292; H04N 23/611; H04N 23/695; G06T 2207/30196; G06T 2207/30204

(57) ABSTRACT

A system includes an imaging device and a processing device. The processing device detects a subject position in an image captured by the imaging device from the image; converts the detected subject position in the image to a subject position in a global coordinate system; and corrects the converted subject position. The subject position is corrected by applying a filter to the subject position according to a moving speed of the subject position.

### BACKGROUND

### Field of the Technology

The aspect of the embodiments relates to a system, a processing device, a method of a system, a method of a processing device, and a storage medium.

### Description of the Related Art

There is a technique of detecting a position of a subject from an image captured by an imaging device. Information of the detected position of the subject is used, for example, for an imaging device to track the subject. Japanese Patent Laid-Open No. 2007-208425 discloses a method of displaying an identification mark indicating a subject along with an image on a display device to track movement of an identification region which is a position of a subject, in which tracking response characteristics of a position of the identification mark with respect to the movement of the identification region vary in a moving direction of the identification region.

When a motion or a posture of a subject changes and a position of the subject is identified without considering whether the motion or the posture of the subject is a predetermined motion or a predetermined posture, accuracy of the identified position of the subject may decrease. For example, when the subject jumps, the jumping of the subject detected from a captured image may be identified as a change of the subject position in an anteroposterior direction instead of a change of the subject position in a vertical direction according to a positional relationship between an imaging device and a subject. In this case, the position of the subject may be identified as a position different from an actual position.

### SUMMARY

According to an aspect of the embodiments, a system includes an imaging device and a processing device, the processing device detects a subject position in an image captured by the imaging device from the image; convers the detected subject position in the image to a subject position in a global coordinate system; corrects the converted subject position; and applying a filter to the subject position according to a moving speed of the subject position.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating the entire configuration of an imaging system.

FIG. 2 is a diagram illustrating an example of a hardware configuration of a control device, an overhead-view camera, and a tracking camera.

FIG. 3 is a diagram illustrating a functional configuration of the control device.

FIG. 4A is a diagram illustrating an image captured by the overhead-view camera, and

FIG. 4B is a diagram illustrating the image illustrated in FIG. 4A when understood in a global coordinate system.

FIG. 5A is a diagram illustrating a subject detection method that is performed by a subject detecting unit, and FIG. 5B is a diagram illustrating a subject coordinates conversion method that is performed by a conversion unit.

FIG. 6 is a diagram illustrating a method of calculating a pan value of the tracking camera used for the tracking camera to track a tracked subject that is performed by a control information generating unit.

FIG. 7 is a diagram illustrating a method of calculating a tilt value of the tracking camera used for the tracking camera to track a tracked subject that is performed by the control information generating unit.

FIG. 8 is a diagram illustrating a coordinate management table.

FIG. 9A is a flowchart illustrating a flow of an overhead view imaging process, FIG. 9B is a flowchart illustrating a flow of a position identifying process, and FIG. 9C is a flowchart illustrating a flow of a tracking process.

FIG. 10 is a flowchart illustrating a flow of a filtering process

FIG. 11 is a diagram illustrating a graph of a Fermi function.

FIGS. 12A and 12B are diagrams illustrating an example in which a subject adopts a predetermined motion.

FIGS. 13A, 13B, and 13C are diagrams illustrating a change in coordinates of a subject with the elapse of time.

### DESCRIPTION OF THE EMBODIMENTS

Hereinafter, embodiments of the disclosure will be described with reference to the accompanying drawings. The following embodiments do not limit the description in the appended claims. A plurality of features are described in the embodiments, all thereof are not essential to the disclosure, and the plurality of features may be arbitrarily combined. In the accompanying drawings, the same or similar constituents will be referred to by the same reference signs, and repeated description thereof will be omitted.

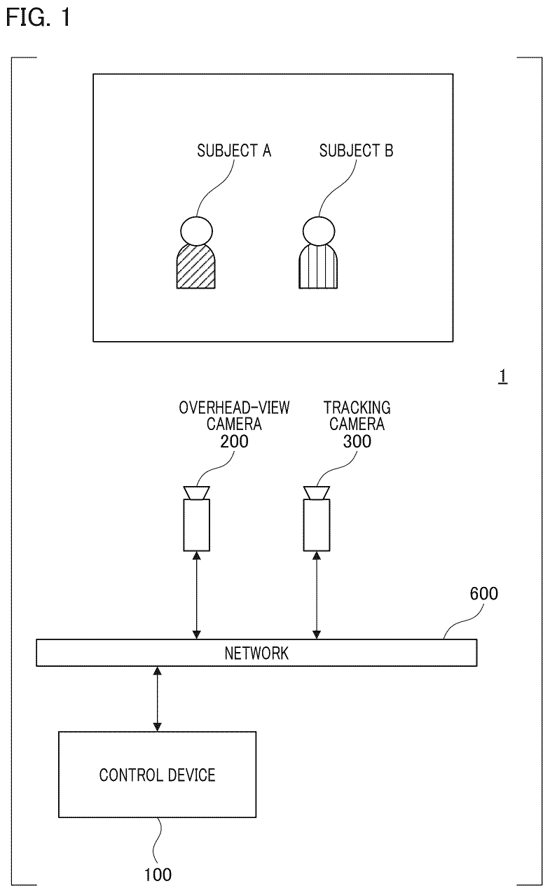

FIG. 1 is a diagram illustrating the entire configuration of an imaging system 1.

An imaging system 1 according to the embodiment images a subject using two cameras. More specifically, the imaging system 1 causes a first camera of the two cameras to image a subject in an overhead view, identifies a position of the subject from the captured image, and causes a second camera to captures an image in a state in which the subject is tracked on the basis of the identification result. The subject to be tracked by the imaging system 1 is, for example, a person. The subject to be tracked by the imaging system 1 may be a living organism other than a person or may be an object other than a living organism. In the following description, the subject to be tracked by the imaging system 1 may be referred to as a tracked subject.

The imaging system 1 includes a control device 100, an overhead-view camera 200, and a tracking camera 300. The control device 100, the overhead-view camera 200, and the tracking camera 300 are connected via a network 600.

The control device 100 which is an example of a processing device is a server that controls the overhead-view camera 200 and the tracking camera 300.

The control device 100 acquires an image captured by the overhead-view camera 200, detects a tracked subject from the acquired image, and identifies coordinates of the detected tracked subject in the image. The control device 100 identifies a position of the tracked subject by converting the identified coordinates of the tracked subject in the image to a global coordinate system. The control device 100 causes the tracking camera 300 to capture an image in a state in which the tracked subject is tracked by transmitting information indicating the identified position of the tracked subject to the tracking camera 300.

Specifically, the control device 100 calculates a moving speed of the subject from a past position and a current position of the subject and applies a filter thereto to remove fast movement. The control device 100 integrates the moving speed of the subject and adds the integrated moving speed to the calculated subject position. Then, the control device 100 calculates a weighting coefficient from a variance of an observed subject position, weighted-sums the observed subject position and the cumulative subject position, and calculates a corrected subject position. As a result, the observed subject position increases when movement of the subject decreases, and the cumulative subject position increases when movement of the subject increases. The control device 100 determines a tracked subject from the detected subject and changes an imaging direction and an imaging range of the tracking camera 300 to an imaging direction and an imaging range of the tracked subject on the basis of the corrected subject position.

A computer can be used as the control device 100. The control device 100 may be a high-performance computer such as a workstation. The control device 100 may be constituted by a single computer or may be realized by distributed processes using a plurality of computers. The control device 100 may be realized over virtual hardware which is provided by cloud computing.

The overhead-view camera 200 which is an example of a first imaging device images subjects including the tracked subject in an overhead view in response to an instruction from the control device 100. In the embodiment, since an imaging angle of view of the overhead-view camera 200 is fixed to a wide angle, the overhead-view camera 200 can image subjects including the tracked subject in an overhead view. In the illustrated example, the overhead-view camera 200 includes subject A and subject B in the angle of view and captures an image. The overhead-view camera 200 transmits the captured image to the control device 100.

The tracking camera 300 which is an example of a second imaging device captures an image in a state in which the tracked subject is tracked on the basis of an instruction from the control device 100. The tracking camera 300 in the embodiment has a PTZ function of controlling pan (panoramic), tilt, and zoom. Panning is movement of an optical axis of the imaging device in the horizontal direction. Tilting is movement of the optical axis of the imaging device in the vertical direction. Zooming includes zoom-up (telescope) and zoom-out (wide angle). Panning and tilting are functions of changing an imaging direction of the imaging device, and zooming is a function of changing an imaging range (an imaging angle of view) of the imaging device. In the illustrated example, the tracking camera 300 can capture an image in a state in which at least one of subject A and subject B is tracked.

In the embodiment, the overhead-view camera 200 and the tracking camera 300 are disposed at separated positions such that at least one of the imaging position and the imaging direction is different. The overhead-view camera 200 images the tracked subject from a position farther from the tracked subject than the tracking camera 300.

The network 600 is realized, for example, by a local area network (LAN) or a wide area network (WAN) such as the Internet. The network 600 may be realized by one or a combination of a telephone line, a dedicated digital line, an asynchronous transfer mode (ATM), a frame relay line, a cable television line, and a data-broadcast wireless line in addition to the Internet.

In the illustrated example, the number of tracking cameras 300 provided in the imaging system 1 is 1, but the disclosure is not limited thereto. The number of tracking cameras 300 provided in the imaging system 1 may be an arbitrary number.

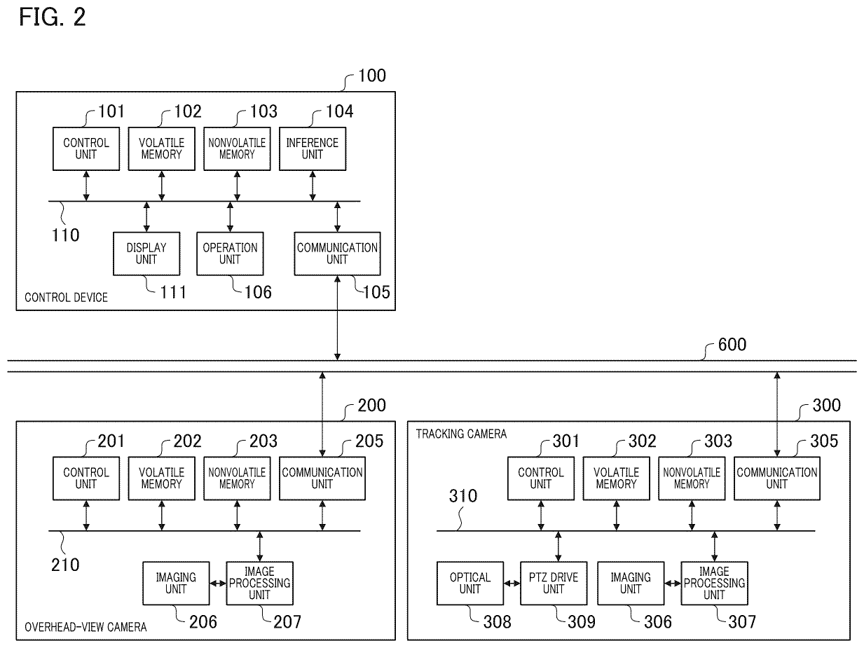

FIG. 2 is a diagram illustrating an example of hardware configurations of the control device 100, the overhead-view camera 200, and the tracking camera 300.

The control device 100 includes a control unit 101, a volatile memory 102, a nonvolatile memory 103, an inference unit 104, a communication unit 105, an operation unit 106, and a display unit 111. The control unit 101, the volatile memory 102, the nonvolatile memory 103, the inference unit 104, the communication unit 105, the operation unit 106, and the display unit 111 are connected via an internal bus 110.

The control unit 101 controls the control device 100 as a whole. The control unit 101 includes a processor (CPU). The control unit 101 controls the constituents of the control device 100 by executing a control program stored in the nonvolatile memory 103.

The volatile memory 102 is a main storage device such as a RAM. Constants and variables for operation of the control unit 101, a control program or an inference program read from the nonvolatile memory 103, and the like are loaded to the volatile memory 102. The volatile memory 102 stores information such as image data or an inference program received from an external device via the communication unit 105. The volatile memory 102 stores an image captured by the overhead-view camera 200. The volatile memory 102 has a storage capacity enough to maintain such information.

The nonvolatile memory 103 is an auxiliary storage device such as an EEPROM, a flash memory, a hard disk drive (HDD), a solid state driver (SSD), or a memory card. The nonvolatile memory 103 stores an operating system (OS) which is basic software executed by the control unit 101, a control program including an application for realizing applicable functions in cooperation with the OS, an inference program used in an inference process by the inference unit 104, and the like.

The inference unit 104 performs an inference process using a trained inference model and inference parameters in accordance with an inference program. The inference unit 104 performs an inference process of estimating presence or a position of a predetermined subject and feature information of a subject from an image captured by the overhead-view camera 200. The inference process in the inference unit 104 can be performed by an arithmetic processing device specialized in an image processing or an inference process such as a graphics processing unit (GPU). A GPU is a processor that can perform a large amount of product-sum arithmetic and has an arithmetic processing capability capable of performing matrix operations of a neural network or the like for a short time. The inference process in the inference unit 104 may be realized by a reconfigurable logic circuit such as a field-programmable gate array (FPGA). The inference process may be cooperatively performed by the CPU of the control unit 101 and the GPU or may be performed by one of the CPU of the control unit 101 and the GPU.

The communication unit 105 is an interface (I/F) based on a wired communication standard such as Ethernet (registered trademark) or an interface based on a wireless communication standard such as Wi-Fi (registered trademark). The communication unit 105 is connected to an external device such as the overhead-view camera 200 and the tracking camera 300 via the network 600 and transmits and receives data to and from the external device. The control unit 101 realizes communication with the external device by controlling the communication unit 105. The communication system is not limited to Ethernet (registered trademark) or Wi-Fi (registered trademark) and may employ a communication standard such as IEEE 1394.

The operation unit 106 is an operation member such as various switches, buttons, and a touch panel that receive various operations from a user and outputs operation information to the control unit 101. The operation unit 106 provides a user interface for allowing a user to operate the control device 100.

The display unit 111 performs display of an image or a subject recognition result, display of a graphical user interface (GUI) for an interactive operation, and the like. The display unit 111 is a display device such as a liquid crystal display or an organic EL display. The display unit 111 may be unified with the control device 100 or may be an external device connected to the control device 100.

The overhead-view camera 200 includes a control unit 201, a volatile memory 202, a nonvolatile memory 203, a communication unit 205, an imaging unit 206, and an image processing unit 207. The control unit 201, the volatile memory 202, the nonvolatile memory 203, the communication unit 205, the imaging unit 206, and the image processing unit 207 are connected via an internal bus 210.

The control unit 201 controls the overhead-view camera 200 as a whole. The control unit 201 includes a processor (CPU) and controls the constituents of the overhead-view camera 200 by executing a control program stored in the nonvolatile memory 203.

The volatile memory 202 is a main storage device such as a RAM. Constants and variables for operation of the control unit 201, a control program or an inference program read from the nonvolatile memory 203, and the like are loaded to the volatile memory 202. The volatile memory 202 stores an image captured by the imaging unit 206 and processed by the image processing unit 207. The volatile memory 202 has a storage capacity enough to maintain such information.

The nonvolatile memory 203 is an auxiliary storage device such as an EEPROM, a flash memory, a hard disk drive (HDD), a solid state driver (SSD), or a memory card. The nonvolatile memory 203 stores an operating system (OS) which is basic software executed by the control unit 201, a control program including an application for realizing applicable functions in cooperation with the OS, and the like.

The imaging unit 206 includes an image sensor constituted by a charge-coupled device (CCD) or a complementary metal-oxide semiconductor (CMOS) device and converts an optical image of a subject to an electrical signal.

The image processing unit 207 performs various types of image processing on image data output from the imaging unit 206 or image data read from the volatile memory 202. Various types of image processing include, for example, image processing processes such as noise reduction, edge emphasis, and enlargement/reduction, image correcting processes such as contrast correction, brightness correction, and color correction, and a trimming process or a cropping process of cutting out a part of image data. The image processing unit 207 converts image data on which image processing has been performed to an image file in a predetermined format (for example, JPEG) and records the image file in the nonvolatile memory 203. The image processing unit 207 performs a predetermined arithmetic operation process using the image data, and the control unit 201 performs an auto-focus (AF) process and an automatic exposure (AE) process on the basis of the arithmetic operation result.

The communication unit 205 is an interface (I/F) based on a wired communication standard such as Ethernet (registered trademark) or an interface based on a wireless communication standard such as Wi-Fi (registered trademark). The communication unit 205 is connected to an external device such as the control device 100 via the network 600 and transmits and receives data to and from the external device. The control unit 201 realizes communication with the external device by controlling the communication unit 205. The communication system is not limited to Ethernet (registered trademark) or Wi-Fi (registered trademark) and may employ a communication standard such as IEEE 1394.

The tracking camera 300 includes a control unit 301, a volatile memory 302, a nonvolatile memory 303, a communication unit 305, an imaging unit 306, an image processing unit 307, an optical unit 308, and a PTZ drive unit 309. The control unit 301, the volatile memory 302, the nonvolatile memory 303, the communication unit 305, the imaging unit 306, the image processing unit 307, the optical unit 308, and the PTZ drive unit 309 are connected via an internal bus 310.

The control unit 301 controls the tracking camera 300 as a whole. The control unit 301 includes a processor (CPU) and controls the constituents of the tracking camera 300 by executing a control program stored in the nonvolatile memory 303.

The volatile memory 302 is a main storage device such as a RAM. Constants and variables for operation of the control unit 301, a control program or an inference program read from the nonvolatile memory 303, and the like are loaded to the volatile memory 302. The volatile memory 302 stores an image captured by the imaging unit 306 and processed by the image processing unit 307. The volatile memory 302 has a storage capacity enough to maintain such information.

The nonvolatile memory 303 is an auxiliary storage device such as an EEPROM, a flash memory, a hard disk drive (HDD), a solid state driver (SSD), or a memory card. The nonvolatile memory 303 stores an operating system (OS) which is basic software executed by the control unit 301, a control program including an application for realizing applicable functions in cooperation with the OS, and the like.

The imaging unit 306 includes an image sensor constituted by a charge-coupled device (CCD) or a complementary metal-oxide semiconductor (CMOS) device and converts an optical image of a subject to an electrical signal.

The image processing unit 307 performs various types of image processing on image data output from the imaging unit 306 or image data read from the volatile memory 302. Various types of image processing include, for example, image processing processes such as noise reduction, edge emphasis, and enlargement/reduction, image correcting processes such as contrast correction, brightness correction, and color correction, and a trimming process or a cropping process of cutting out a part of image data. The image processing unit 307 converts image data on which image processing has been performed to an image file in a predetermined format (for example, JPEG) and records the image file in the nonvolatile memory 303. The image processing unit 307 performs a predetermined arithmetic operation process using the image data, and the control unit 301 performs an auto-focus (AF) process and an automatic exposure (AE) process on the basis of the arithmetic operation result.

The communication unit 305 is an interface (I/F) based on a wired communication standard such as Ethernet (registered trademark) or an interface based on a wireless communication standard such as Wi-Fi (registered trademark). The communication unit 305 is connected to an external device such as the control device 100 via the network 600 and transmits and receives data to and from the external device. The control unit 301 realizes communication with the external device by controlling the communication unit 305. The communication system is not limited to Ethernet (registered trademark) or Wi-Fi (registered trademark) and may employ a communication standard such as IEEE 1394.

The optical unit 308 includes a lens group including a zoom lens or a focusing lens, a shutter having an aperture function, and a mechanism for driving these optical members. The optical unit 308 drives the optical members to rotate an imaging direction of the tracking camera 300 around a pan (P) axis (the horizontal direction) or a tilt (T) axis (the vertical direction). The optical unit 308 changes an imaging range (an imaging angle of view) of the tracking camera 300 along a zoom (Z) axis (an enlargement/reduction direction).

The PTZ drive unit 309 includes mechanical elements for driving the optical unit 308 in the PTZ directions and an actuator such as a motor and drives the optical unit 308 in the PTZ directions under the control of the control unit 301.

The zoom function in the embodiment is not limited to an optical zoom function of changing a focal distance by moving a zoom lens and may be realized by a digital zoom of cutting out and enlarging a part of captured image data or may be a combination of an optical zoom and a digital zoom.

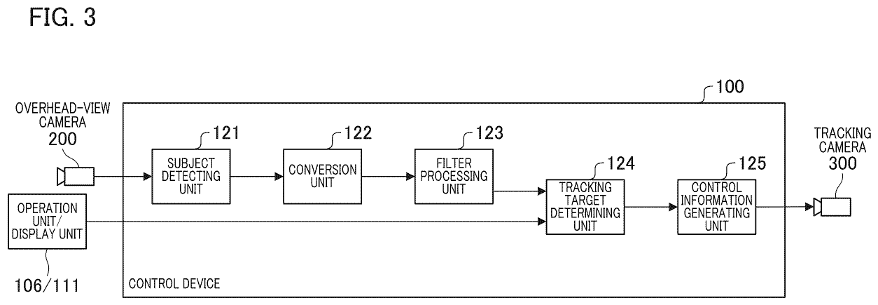

FIG. 3 is a diagram illustrating a functional configuration of the control device 100.

The control device 100 includes a subject detecting unit 121, a conversion unit 122, a filter processing unit 123, a tracking target determining unit 124, and a control information generating unit 125.

In the embodiment, the functions of the functional units of the control device 100 illustrated in FIG. 3 are realized by causing the control unit 101 or the inference unit 104 of the control device 100 to load software stored in the nonvolatile memory 103 to the volatile memory 102 and to execute the software.

The subject detecting unit 121 which is an example of a detection unit detects a subject appearing in an image captured by the overhead-view camera 200 and identifies coordinates of the subject in the image as a position of the detected subject. The subject detecting unit 121 transmits information indicating the identified coordinates of the subject in the image along with information indicating a time at which detection of the subject has been performed and information for identifying the detected subject to the conversion unit 122. Information indicating the coordinates of the subject identified by the subject detecting unit 121 in the image captured by the overhead-view camera 200 may be referred to as image coordinate information in the following description. Information indicating the time at which detection of the subject has been performed by the subject detecting unit 121 may be referred to as time information in the following description. Information for identifying the subject detected by the subject detecting unit 121 may be referred to as identification information in the following description.

The subject detecting unit 121 performs detection of a subject, identification of a position of the subject, and generation of image coordinate information, time information, and identification information whenever an image captured by the overhead-view camera 200 is received by the control device 100.

The time information may be information indicating a time at which the image used for the subject detecting unit 121 to detect a subject has been captured. The time information may be information indicating a time having elapsed from the time at which a predetermined subject has been first detected in the image captured by the overhead-view camera 200 by the subject detecting unit 121 until the predetermined subject has been detected in a target image by the subject detecting unit 121. In other words, in one embodiment, the time information has only to be information capable of detection times when the predetermined subject has been detected in a plurality of images with different imaging times in the overhead-view camera 200.

The conversion unit 122 which is an example of a conversion unit converts coordinates of a subject identified by image coordinate information received from the subject detecting unit 121 in the image to a global coordinate system. The conversion unit 122 transmits information indicating the global coordinates as the position of the subject to the filter processing unit 123 in correlation with the image coordinate information, the time information, and the identification information used for conversion. The information indicating the global coordinates of the subject generated by the conversion unit 122 may be referred to as global coordinate information in the following description.

The filter processing unit 123 which is an example of a correction unit performs a filtering process on the global coordinate information and corrects the global coordinates of the subject identified from the global coordinate information. The filter processing unit 123 transmits information indicating the corrected global coordinates of the subject to the tracking target determining unit 124 in correlation with global coordinate information, time information, and identification information used for correction. The information indicating the global coordinates of the subject corrected by the filter processing unit 123 may be referred to as corrected coordinate information in the following description.

The tracking target determining unit 124 determines a tracked subject to be tracked by the imaging system 1 using information such as the corrected coordinate information received from the filter processing unit 123.

In the embodiment, for example, the control unit 101 of the control device 100 displays an image captured by the overhead-view camera 200 along with a result of detection of the subject from the subject detecting unit 121 for the image on the display unit 111. In this case, a user selects which of the subjects detected by the subject detecting unit 121 is used as a tracked subject by operating the operation unit 106. The tracking target determining unit 124 determines the tracked subject, for example, by comparing an image of the tracked subject selected by the user with an image of the subject identified from the corrected coordinate information. The tracking target determining unit 124 transmits image coordinate information, converted coordinate information, corrected coordinate information, time information, and identification information associated with the determined tracked subject to the control information generating unit 125.

The method of determining a tracked subject is not limited to the aforementioned example.

For example, a plurality of subjects may be included in an image captured by the overhead-view camera 200, and a plurality of tracking cameras 300 may be provided. In this case, there may be a tracking camera 300 for tracking a tracked subject selected by a user and a tracking camera 300 for tracking a subject not selected by the user. In this case, a plurality of subjects included in an image captured by the overhead-view camera 200 are comprehensively tracked.

For example, a subject closest to the tracking camera 300 out of subjects appearing in the image captured by the overhead-view camera 200 may be determined as a tracked subject. In this case, a subject which is likely to be included in an angle of view of the tracking camera 300 is tracked.

The control information generating unit 125 generates information indicating a pan value and a tilt value of the tracking camera 300 as information necessary for controlling the tracking camera 300 causing the tracking camera 300 to track the tracked subject determined by the tracking target determining unit 124. More specifically, the control information generating unit 125 calculates the pan value and the tilt value at which the tracked subject is likely to be included in the imaging direction of the tracking camera 300 from information indicating the global coordinates of the tracking camera 300 and the corrected coordinate information of the tracked subject.

The method of conversion performed by the conversion unit 122 will be described below.

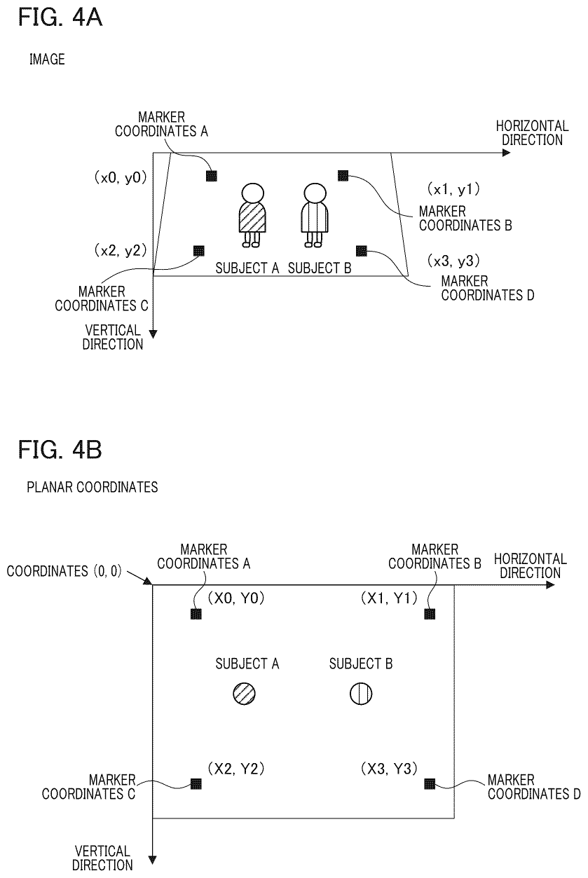

FIG. 4A is a diagram illustrating an image captured by the overhead-view camera 200. FIG. 4B is a diagram illustrating an example in which the image illustrated in FIG. 4A is understood in the global coordinate system. The image illustrated in FIG. 4A is an image captured by the overhead-view camera 200 in a state in which subject A and subject B illustrated in FIG. 1 are included in the angle of view of the overhead-view camera 200.

When the pan value is calculated such that the tracked subject is included in the imaging direction of the tracking camera 300 and an angle is calculated in a planar coordinate space perpendicular to an axis in which the panning operation is performed by the tracking camera 300, the arithmetic operation is simplified. For example, when the tracking camera 300 is installed perpendicular to a grounded surface (a reference position) such as the floor or the ground, the coordinate space perpendicular to the axis in which the tracking camera 300 performs a panning operation is understood as a space illustrated in FIG. 4B. That is, the coordinate space perpendicular to the axis in which the tracking camera 300 is a coordinate space parallel to the reference position (a coordinate space when a space including the tracking camera 300 or a subject is seen from just above).

In the embodiment, the pan value is calculated in the coordinate system in which an imaging area of the overhead-view camera 200 has been seen from just above on the basis of the assumption that the tracking camera 300 is installed perpendicular to the reference position. That is, the conversion unit 122 converts a position of the subject detected by the subject detecting unit 121 in the coordinate system of the image illustrated in FIG. 4A to the coordinate system in which the imaging area of the overhead-view camera 200 has been seen from just above as illustrated in FIG. 4B. Accordingly, the conversion unit 122 is also understood as an identification unit identifying a position when the subject is seen from just above on the basis of the position determined by the subject detecting unit 121. The coordinate system of the image illustrated in FIG. 4A may be referred to as an image coordinate system in the following description. The coordinate system when the imaging area of the overhead-view camera 200 is seen from just above may be referred to as a planar coordinate system in the following description.

The subject detecting unit 121 identifies the coordinates of subject A and subject B in the image coordinate system from the image illustrated in FIG. 4A and information indicating the position of the overhead-view camera 200 in the planar coordinate system. Then, the subject detecting unit 121 generates image coordinate information, time information, and identification information for each of subject A and subject B. The position of the overhead-view camera 200 is a position in the planar coordinate system and is known because it is measured in advance according to a user's operation or using a sensor which is not illustrated. The information generated by the subject detecting unit 121 is stored in the volatile memory 102.

The conversion unit 122 converts the position of the subject in the image coordinate system to the planar coordinate system using Equation 1.

$$( \begin{matrix}X \\ Y \\ W\end{matrix} ) = H ( \begin{matrix}x \\ y \\ 1\end{matrix} ) \qquad ( Equation 1 )$$

In Equation 1, x is a horizontal coordinate in the image coordinate system, y is a vertical coordinate in the image coordinate system, X is a horizontal coordinate in the planar coordinate system, Y is a vertical coordinate in the planar coordinate system, and H is a homography conversion matrix. By substituting marker coordinates A, marker coordinates B, marker coordinates C, and marker coordinates D illustrated in FIGS. 4A and 4B into Equation 1, the homography conversion matrix H is calculated.

The marker coordinates are position information of a marker installed in the planar coordinate system and have a known value which has been measured in advance manually or using a sensor which is not illustrated. The markers are the same stamps of a color different from the color of the floor or the ground and are not particularly limited as long as they can be measured according to a user's operation or using a sensor which is not illustrated. For example, when the sensor which is not illustrated is a camera, a maker position is acquired by extracting the color of a marker from an image captured with the marker as a stamp of an arbitrary color. The homography conversion matrix H and the marker coordinates are stored in the volatile memory 102 in advance.

The conversion unit 122 generates global coordinate information by converting the image coordinate system for subject A and subject B to the planar coordinate system using Equation 1. The information generated by the conversion unit 122 is stored in the volatile memory 102.

The method of detecting a subject performed by the subject detecting unit 121 and the method of converting coordinates of the subject performed by the conversion unit 122 will be described below.

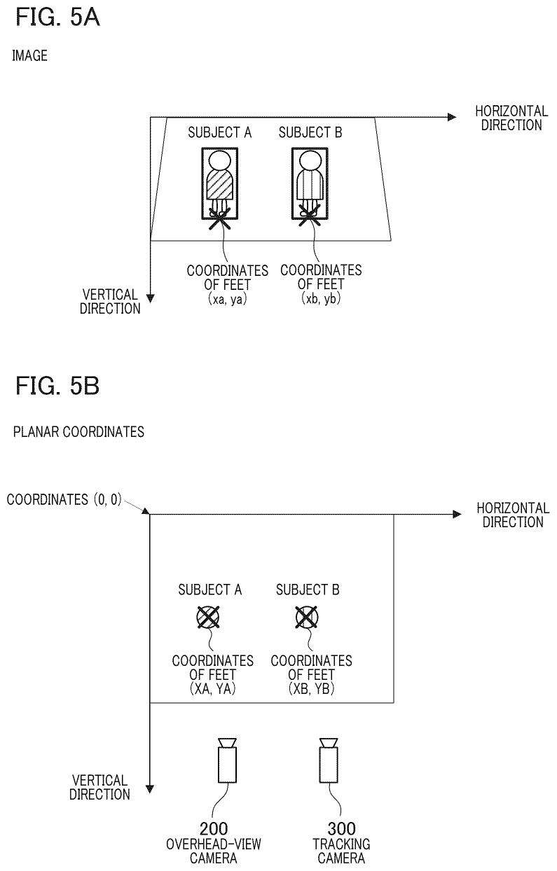

FIG. 5A is a diagram illustrating the method of detecting a subject performed by the subject detecting unit 121, and FIG. 5B is a diagram illustrating the method of converting coordinates of a subject performed by the conversion unit 122.

In the embodiment, the subject detecting unit 121 detects a subject from an image by performing an image recognition process using an inference model for subject detection generated through machine learning such as deep learning. The inference model for subject detection is a model that outputs image coordinate information of a subject appearing in an input image using an image captured by the overhead-view camera 200 as an input.

An example in which a subject is detected by the subject detecting unit 121 is illustrated in FIG. 5A. As illustrated in FIG. 5A, the subject detecting unit 121 detects coordinates of rectangular parts circumscribing subject A and subject B detected from the image captured by the overhead-view camera 200 as subject positions. In the illustrated in example, coordinates of feet of subject A and subject B are detected as the subject positions. The subject detecting unit 121 generates information indicating the detected coordinates as image coordinate information and stores the generated image coordinate information in the volatile memory 102.

The method of detecting a subject performed by the subject detecting unit 121 is not limited to the inference process using a trained model. The method of detecting a subject may employ, for example, a SIFT method of detecting a subject in combination of local feature points in an image and a template matching method of detecting a subject on the basis of similarity between a template image and a subject.

The subject detecting unit 121 outputs identification information by inputting the image coordinate information and the image captured by the overhead-view camera 200 to a trained inference model for subject identification generated through machine learning such as deep learning and performing an inference process. The inference model for subject identification is different from the inference model for subject detection.

The inference model for subject identification is a trained model which has been trained using training data for each of information in which images obtained by imaging a predetermined subject in a plurality of different imaging directions and information for identifying the predetermined subject are correlated. In this trained model, learning is performed such that similarity between feature information in images of the same subject increases. Feature information is output by inputting an image of a subject which is cut out on the basis of the image coordinate information of the subject which is an output of the inference model for subject detection to the inference model for subject identification. An example of the feature information is a multidimensional vector of responses of a convolution layer of a convolution neural network.

In this way, the subject detecting unit 121 is also understood as an acquisition unit that acquires feature information of a subject from an image captured by an imaging unit.

The inference model for subject detection and the inference model for subject identification are stored in advance in the nonvolatile memory 103.

The subject detecting unit 121 calculates similarity in feature information between images of subjects acquired by inputting the images of the subjects detected using the inference model for subject detection with images of a current frame and a past frame as an input to the inference model for subject identification. The similarity is calculated using cosine similarity. The cosine similarity is an index that approaches 1 as multidimensional vectors which are feature information of subject images are more similar and approaches 0 as the multidimensional vectors are more different. The same identification information is given to subjects having the largest similarity between the past frame and the current frame. The similarity calculating method is not limited thereto, and any method can be used as long as a higher numerical value is output as feature information is more similar and a lower numerical value is output as feature information is more different.

In the embodiment, feature information is used to give identification information, but the disclosure is not limited thereto. The subject detecting unit 121 may compare positions or sizes of rectangular information of detected subjects using rectangular information of the subjects acquired using the inference model for subject detection between the current frame and the past frame and give the same identification information to the most similar subjects. The subject detecting unit 121 may employ a method of predicting a position of rectangular information of the current frame from a change of a position of rectangular information for the same identification information in the several past frames using a Kalman filter or the like and giving the same identification information to subjects closest to the predicted position of the rectangular information. The subject detecting unit 121 may give the identification information in combination of the aforementioned methods. By using this method, it is possible to enhance the accuracy of giving identification information when subjects with similar appearance suddenly enter the imaging angle of view.

As described above, the subject detecting unit 121 outputs image coordinate information by performing an inference process using the inference model for subject detection using an image captured by the overhead-view camera 200 as an input. The subject detecting unit 121 outputs identification information by performing an inference process by inputting the image coordinate information and the image captured by the overhead-view camera 200 to the inference model for subject identification.

The conversion unit 122 converts the detection result from the subject detecting unit 121 illustrated in FIG. 5A to the planar coordinate system as illustrated in FIG. 5B. In the illustrated example, the conversion unit 122 reads the homography conversion matrix H from the volatile memory 102 and converts coordinates (xa, ya) of subject A in the image coordinate system to coordinates (XA, YA) in the planar coordinate system by substituting the coordinates of subject A into (x, y) in Equation 1. The conversion unit 122 converts coordinates (xb, yb) of subject B in the image coordinate system to coordinates (XB, YB) in the planar coordinate system by substituting the coordinates of subject B into (x, y) in Equation 1. The conversion unit 122 generates information indicating the converted coordinates as global coordinate information and stores the global coordinate information in the volatile memory 102.

When a detection target as a position of a subject is coordinates of feet, the subject detecting unit 121 may detect coordinates of the subject in the image using feature information of the subject. For example, the subject detecting unit 121 detects the skeleton of the subject by performing an image recognition process using an inference model for skeleton detection using an image indicating an area of the subject output from the image using the inference model for subject detection as an input. Then, the subject detecting unit 121 can calculate coordinates of the subject in the image from the coordinates of the ankles of the detected skeleton. When an inference model for skeleton detection not outputting coordinates of the feet of the subject is used, the subject detecting unit 121 may estimate the feet coordinates from coordinates of other joints. When the inference model for skeleton detection is used, it is possible to accurately acquire feet coordinates even when a subject adopts various postures.

In this way, the subject detecting unit 121 and the filter processing unit 123 are also understood as a determination unit that determines a position of a subject from a grounded part of the subject on the basis of feature information.

The methods of calculating a pan value and a tilt value of the tracking camera 300 for causing the tracking camera 300 to track a tracked subject which are performed by the control information generating unit 125 will be described below.

The control information generating unit 125 calculates the pan value and the tilt value such that a tracked subject is included in the imaging direction of the tracking camera 300 on the basis of information indicating the coordinates of the tracking camera 300 in the planar coordinate system and corrected coordinate information of the tracked subject. The tracking camera 300 may transmit, for example, information indicating the coordinates of the tracking camera 300 in the planar coordinate system to the control device 100 in advance. The information indicating the coordinates of the tracking camera 300 in the planar coordinate system is stored in the volatile memory 102 of the control device 100.

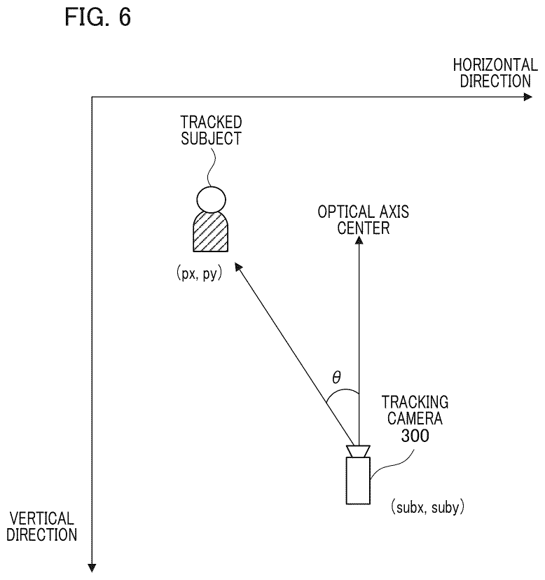

FIG. 6 is a diagram illustrating the method of calculating the pan value of the tracking camera 300 for causing the tracking camera 300 to track the tracked subject which is performed by the control information generating unit 125.

An angle θ formed by a line extending an optical axis center of the tracking camera 300 and a line connecting the tracking camera 300 and a tracked subject is calculated using Equation 2.

$$θ = {tan}^{- 1} \frac{px - subx}{py - suby} ( rad ) \qquad ( Equation 2 )$$

In Equation 2, px denotes coordinates in the horizontal direction of the tracked subject in the global coordinate system, and py denotes coordinates in the vertical direction of the tracked subject in the global coordinate system. subx is coordinates of the tracking camera 300 in the horizontal direction in the global coordinate system, and suby is coordinates of the tracking camera 300 in the vertical direction in the global coordinate system. px and py are identified by the corrected coordinate information of the tracked subject.

The control information generating unit 125 calculates the pan value of the tracking camera 300 for causing the tracking camera 300 to track the tracked subject on the basis of the angle θ.

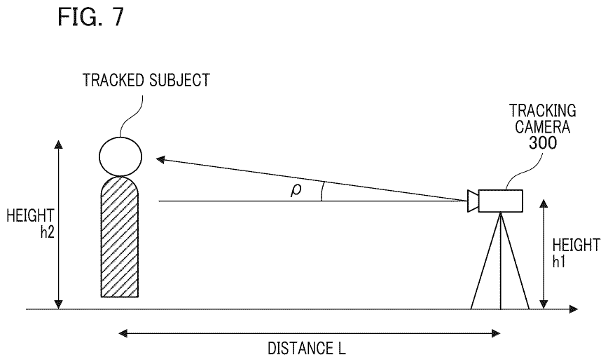

FIG. 7 is a diagram illustrating the method of calculating the tilt value of the tracking camera 300 for causing the tracking camera 300 to track the tracked subject which is performed by the control information generating unit 125.

A distance L from the tracking camera 300 to the tracked subject is calculated using Equation 3.

$$L = \sqrt{{( px - subx )}^{2} + {( py - suby )}^{2}} \qquad ( Equation 3 )$$

The height of the optical axis of the tracking camera 300 with respect to the grounded surface of the tracking camera 300 is defined as a height h1. The height of a predetermined part of the tracked subject with respect to the grounded surface of the tracked subject is defined as a height h2. The predetermined part is, for example, a face when the tracked subject is a person. In this case, an angle ρ formed by a line extending from the optical axis center of the tracking camera 300 and the line connecting the tracking camera 300 and the tracked subject is calculated using Equation 4.

$$ρ = {tan}^{- 1} \frac{h 2 - h 1}{L} ( rad ) \qquad ( Equation 4 )$$

The control information generating unit 125 calculates the tilt value of the tracking camera 300 for causing the tracking camera 300 to track the tracked subject on the basis of the angle ρ.

The height h1 and the height h2 may be stored in advance in the volatile memory 102 or may be measured by a sensor which is not illustrated in real time.

The pan value and the tilt value calculated by the control information generating unit 125 may be speed values for causing the tracking camera 300 to face the tracked subject. In this case, first, the control information generating unit 125 acquires information indicating the current pan value and the current tilt value of the tracking camera 300. Then, the control information generating unit 125 may calculate a panning angular velocity proportional to a difference between the current pan value of the tracking camera 300 and the angle θ and calculate a tilting angular velocity proportional to a difference between the current tilt value of the tracking camera 300 and the angle ρ.

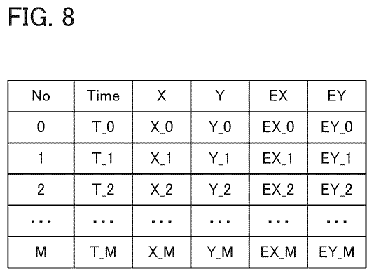

FIG. 8 is a diagram illustrating a coordinate management table. The coordinate management table is a table for managing coordinates as a position of a subject. The coordinate management table is stored in the volatile memory 102 of the control device 100. The coordinate management table is provided for each subject which is identified by identification information.

In the coordinate management table, “No,” “time,” “X,” “Y,” “EX,” and “EY” are shown in correlation with each other.

“ . . . ” shown in the coordinate management table means that description is omitted.

Details of the coordinate management table will be specifically described.

In “No,” a number for identifying a target of information shown in the coordinate management table is described.

In “time,” time information is described.

In “X,” coordinates in the horizontal direction of a subject in the global coordinate system are described.

In “Y,” coordinates in the vertical direction of a subject in the global coordinate system are described.

Information of “X” and “Y” shown in the coordinate management table is global coordinate information.

In “EX,” coordinates corrected by the filter processing unit 123 are described as coordinates in the horizontal direction of a subject in the global coordinate system.

In “EY,” coordinates corrected by the filter processing unit 123 are described as coordinates in the vertical direction of a subject in the global coordinate system.

Information of “EX” and “EY” shown in the coordinate management table is corrected coordinate information.

The subject detecting unit 121 prepares a new “No” in the coordinate management table whenever a subject is detected from an image captured by the overhead-view camera 200 and writes time information to “time” correlated with the prepared “No.” The conversion unit 122 writes generated global coordinate information to “X” and “Y” whenever the global coordinate information is generated. The filter processing unit 123 writes generated corrected coordinate information to “EX” and “EY” whenever the corrected coordinate information is generated.

Process flows that are performed by the constituent devices of the imaging system 1 will be described below.

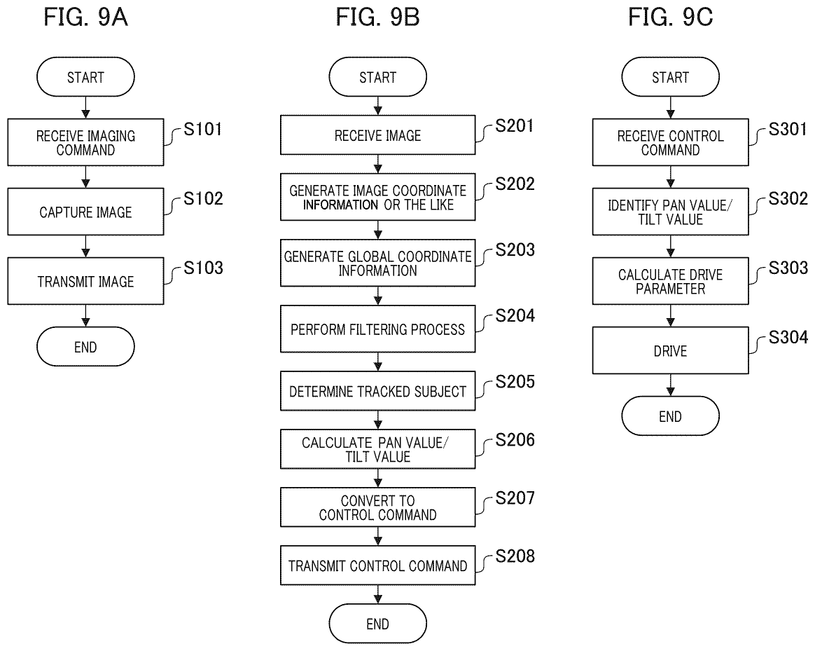

FIG. 9A is a flowchart illustrating a flow of an overhead view imaging process. The overhead view imaging process is a process of causing the overhead-view camera 200 to image a subject. In the embodiment, the overhead view imaging process starts when the control device 100 transmits an imaging command for instructing imaging to the overhead-view camera 200.

The control unit 201 of the overhead-view camera 200 receives the imaging command transmitted from the control device 100 via the communication unit 205 (Step (which may be abbreviated to “S” in the following description) 101).

The control unit 201 captures an image (S102). More specifically, the imaging unit 206 is caused to perform imaging, and the image processing unit 207 is caused to process the captured image to generate an image.

The control unit 201 transmits the captured image to the control device 100 via the communication unit 205 (S103).

FIG. 9B is a flowchart illustrating a flow of a position identifying process. The position identifying process is a process of causing the control device 100 to identify a position of a tracked subject appearing in an image. In the embodiment, when the image captured in the overhead view imaging process (see FIG. 9A) is transmitted from the overhead-view camera 200, the position identifying process starts.

The subject detecting unit 121 of the control device 100 receives the image transmitted in Step 103 of the overhead view imaging process via the communication unit 105 (S201). The received image is stored in the volatile memory 102.

The subject detecting unit 121 detects a subject on the basis of the image received in Step 201, information indicating the position of the overhead-view camera 200, and marker coordinates and generates image coordinate information, time information, and identification information for the detected subject (S202). When a plurality of subjects are detected from the image, the subject detecting unit 121 performs the process of Step 202 for each detected subject.

The conversion unit 122 converts coordinates of the subject in the image to coordinates of the subject in the global coordinate system on the basis of the image received in Step 201 and the image coordinate information generated in Step 202 and generates global coordinate information (S203). The conversion unit 122 performs the process of Step 203 for each subject detected in Step 202.

The filter processing unit 123 performs a filtering process (S204). Although details will be described later, the filtering process is a process of causing the filter processing unit 123 to correct global coordinates of the subject identified from the global coordinate information. The filter processing unit 123 generates corrected coordinate information in the filtering process.

The tracking target determining unit 124 determines which of the subjects detected by the subject detecting unit 121 is a tracked subject on the basis of the corrected coordinate information generated in Step 204 and information indicating a subject preset as a tracked subject (S205).

The control information generating unit 125 calculates a pan value and a tilt value of the tracking camera 300 for causing the tracking camera 300 to track the tracked subject determined in Step 205 (S206).

The control unit 101 of the control device 100 converts the pan value and the tilt value calculated in Step 206 to a control command for controlling the tracking camera 300 (S207).

The control unit 101 transmits the control command converted in Step 207 to the tracking camera 300 via the communication unit 105 (S208).

FIG. 9C is a flowchart illustrating a flow of a tracking process. The tracking process is a process of causing the tracking camera 300 to track a tracked subject. In the embodiment, when the control command for controlling the tracking camera 300 is transmitted from the control device 100 in the position identifying process (see FIG. 9B), the tracking process starts.

The control unit 301 of the tracking camera 300 receives the control command transmitted in Step 208 of the position identifying process via the communication unit 305 (S301).

The control unit 301 identifies the pan value and the tilt value of the tracking camera 300 to track the tracked subject from the control command received in Step 301 (S302).

The control unit 301 calculates drive parameters for controlling a panning operation and a tilting operation at a desired speed in a desired direction on the basis of the pan value and the tilt value identified in Step 302 (S303). The drive parameters are parameters for controlling actuators in the panning direction and the tilting direction which are included in the PTZ drive unit 309. The control unit 301 converts the pan value and the tilt value to the drive parameters with reference to a conversion table stored in the nonvolatile memory 303.

The control unit 301 controls the PTZ drive unit 309 on the basis of the drive parameters calculated in Step 303. In this case, the PTZ drive unit 309 changes the imaging direction of the tracking camera 300 by driving the optical unit 308 in the panning direction and the tilting direction on the basis of the drive parameters (S304).

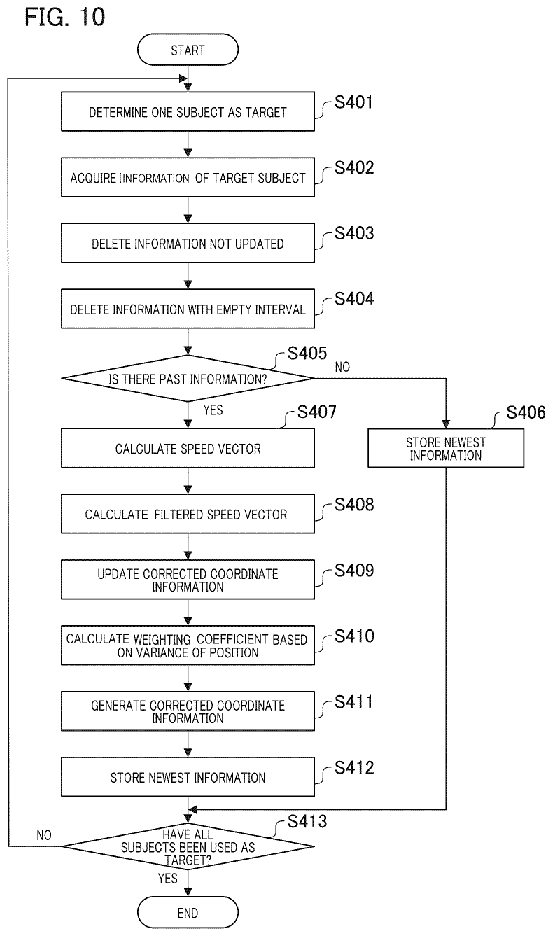

FIG. 10 is a flowchart illustrating a flow of the filtering process (see S204 in FIG. 9B).

The filter processing unit 123 determines one subject which has not been a target of the filtering process out of the subjects detected by the subject detecting unit 121 in the position identifying process under execution as a target of the filtering process (S401). The subject determined as a target of the filtering process in Step 401 may be referred to as a target subject in the following description.

The filter processing unit 123 acquires global coordinate information for the target subject and time information and identification information correlated with the global coordinate information (S402). The global coordinate information acquired by the filter processing unit 123 in Step 402 is global coordinate information generated in Step 203 of the position identifying process under execution. The global coordinate information and the time information acquired in Step 402 may be referred to as newest global coordinate information and newest time information in the following description. Time information indicating a time prior to the newest time information may be referred to as past time information in the following description. Global coordinate information correlated with the past time information may be referred to as past global coordinate information in the following description.

The filter processing unit 123 deletes the global coordinate information, the time information, and the identification information which have not been updated in a predetermined period for the target subject from the volatile memory 102 (S403). More specifically, the filter processing unit 123 deletes time information with an interval of a predetermined time or more from the time identified by the newest time information and global coordinate information correlated with the time information from the coordinate management table. The predetermined time may be any time. Incidentally, the predetermined time may be determined on the basis of a time interval at which a subject moves.

The filter processing unit 123 extracts past time information indicating a time with an interval of a predetermined time from the time identified by the newest time information out of the past time information correlated with the past global coordinate information for the target subject. Then, the filter processing unit 123 deletes the extracted past time information and the global coordinate information correlated with the time information from the coordinate management table (S404). The predetermined time may be any time. Incidentally, the predetermined time may be determined on the basis of a time interval at which a subject moves.

The filter processing unit 123 determines whether there is past global coordinate information for the target subject in the coordinate management table (S405).

When there is no past global coordinate information for the target subject in the coordinate management table (NO in S405), the process flow proceeds to a next step. The filter processing unit 123 stores newest global coordinate information, newest time information, and identification information for the target subject in correlation in the coordinate management table for the target subject (S406). When there is no coordinate management table for the target subject, the filter processing unit 123 first generates the coordinate management table for the target subject and then performs the process of Step 406.

When there is past global coordinate information for the target subject in the coordinate management table (YES in S405), the process flow proceeds to a next step. The filter processing unit 123 calculates a speed vector v of a motion of the target subject on the basis of the newest global coordinate information, the newest time information, the past global coordinate information, and the past time information for the target subject (S407). The speed vector v is calculated using Equation 5.

$$v = XY - XmYm / ( T - Tm ) \qquad ( Equation 5 )$$

In Equation 5, XY is a vector of coordinates in the horizontal direction and coordinates in the vertical direction of the subject identified by the newest global coordinate information. In Equation 5, XmYm is a vector of coordinates in the horizontal direction and coordinates in the vertical direction of the subject identified by the past global coordinate information. In Equation 5, T-Tm is a time interval between the time identified by the newest time information and the time identified by the past time information. The past time information and the past global coordinate information used to calculate the speed vector v are, for example, past time information indicating a time closest to the time identified by the newest time information and past global coordinate information correlated with the time information.

The filter processing unit 123 filters the speed vector v calculated in Step 407 and calculates a filtered speed vector v′ which is the speed vector after being filtered (S408). The filtered speed vector v′ is calculated using Equation 6.

$${v}^{′} = \frac{\vert v \vert}{exp ( \frac{\vert v \vert - u}{kT} + 1 )} \qquad ( Equation 6 )$$

In Equation 6, u is a Fermi function which is an example of a filter function.

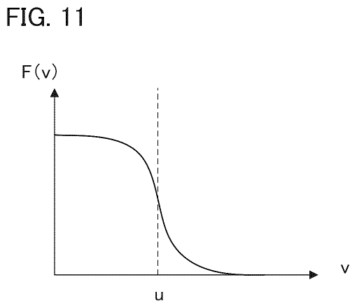

FIG. 11 is a diagram illustrating a graph of a Fermi function.

As illustrated in FIG. 11, when the Fermi function is used to calculated the filtered speed vector v′, the filtered speed vector v′ decreases as the speed vector v increases. When the speed vector v is u, the filtered speed vector v′ is 0.

The filter function used to calculate the filtered speed vector v′ is not limited to the Fermi function. Any filter function may be used as long as the filtered speed vector v′ decreases as the speed vector v increases and the filtered speed vector v′ is 0 when the speed vector v is equal to or greater than a predetermined value. Examples of a filter function other than the Fermi function include a sigmoid function and a hyperbolic tangent function.

In Equation 6, kT is a coefficient of the filter function. A change of the filtered speed vector v′ corresponding to the speed vector v is determined by the value of the coefficient kT. The value of the coefficient kT is determined such that the change of the filtered speed vector v′ corresponding to the speed vector v is a desired change and is stored in advance in the nonvolatile memory 103.

The filter processing unit 123 updates the corrected coordinate information on the basis of the filtered speed vector v′ and the past corrected coordinate information (S409). Update of the corrected coordinate information is performed on the basis of Equation 7.

$$EXuEYu = EXmEYm + {v}^{′} \times ( T - Tm ) \qquad ( Equation 7 )$$

In Equation 7, EXuEYu is a vector of coordinates in the horizontal direction and coordinates in the vertical direction of the subject identified by the updated corrected coordinate information. EXmEYm is a vector of coordinates in the horizontal direction and coordinates in the vertical direction of the subject identified by the past corrected coordinate information. The past corrected coordinate information used for calculation in Equation 7 is corrected coordinate information correlated with the past global coordinate information used to calculate the speed vector v in the coordinate management table. T-Tm is a time interval between the time identified by the newest time information and the time identified by the past time information and is the same index as used in Equation 5.

The filter processing unit 123 calculates a weighting coefficient on the basis of a variance of the position of the target subject (S410). More specifically, the filter processing unit 123 calculates a variance value σ on the basis of the coordinates in the horizontal direction and the coordinates in the vertical direction of the subject identified by the global coordinate information stored in the coordinate management table for the target subject and calculates a weighting coefficient coef using Equation 8.

$$coef = exp ( - \frac{σ}{σbase} ) \qquad ( Equation 8 )$$

When the variance value σ is large, there is a high likelihood that movement of the subject is large, and the weighting coefficient coef also increases in this case. When the variance value σ is small there is a high likelihood that the movement of the subject is small, and the weighting coefficient coef also decreases in this case. In Equation 8, obase is a coefficient of the weighting coefficient coef. The coefficient obase is determined on the basis of a degree of stationary movement of the subject and is stored in advance in the nonvolatile memory 103.

The weighting coefficient coef may be determined on the basis of a motion or a posture of the subject. In this case, the control unit 101 detects a skeleton of the subject by performing an image recognition process using the inference model of skeleton detection with an image indicating the area of the subject from the image using the inference model for subject detection as an input in Step 202 of the position identifying process. Then, the control unit 101 generates information indicating the detected skeleton and information indicating an inference probability of the information indicating the skeleton. Then, the filter processing unit 123 determines whether the subject adopts a predetermined posture at the time of jumping from the information indicating the skeleton in Step 410 and increases the weighting coefficient coef when the subject adopts the predetermined posture more than when the subject does not adopt the predetermined posture. The filter processing unit 123 may determine whether the subject adopts a predetermined motion such as jumping from a time series of information indicating the skeleton in a predetermined period. Then, the filter processing unit 123 may increase the weighting coefficient coef when the subject adopts the predetermined motion more than when the subject does not adopt the predetermined motion.

The filter processing unit 123 generates corrected coordinate information on the basis of the weighting coefficient coef calculated in Step 410 (S411). Generation of the corrected coordinate information is performed on the basis of Equation 9.

$$EXmEYm = coef \times XY + ( 1 - coef ) \times EXuEYu \qquad ( Equation 9 )$$

In Equation 9, EXmEYm is a vector of coordinates in the horizontal direction and coordinates in the vertical direction of the subject identified by the newest corrected coordinate information.

The filter processing unit 123 stores the newest time information, the newest global coordinate information, and the newest corrected coordinate information in correlation in the coordinate management table for the target subject (S412).

The filter processing unit 123 determines whether the processes of Step 402 and steps subsequent thereto have been performed on all the subjects detected by the subject detecting unit 121 in the position identifying process under execution as the target subject (S413). When the processes of Step 402 and steps subsequent thereto have not been performed on all the subjects as the target subject (NO in S413), the processes from Step 401 are repeated. Accordingly, until processes of Step 402 and steps subsequent thereto are performed on all the subjects detected by the subject detecting unit 121 in the position identifying process under execution as the target subject, the processes of Step 402 and steps subsequent thereto are performed for each subject detected by the subject detecting unit 121.

When the processes of Step 402 and steps subsequent thereto have been performed on all the subjects as the target subject (YES in S413), the filtering process ends.

In this way, in the embodiment, tracking of the tracked subject using the tracking camera 300 is performed on the basis of the corrected coordinate information generated by performing the filtering process on the global coordinate information. In this case, it is possible to enhance the accuracy of tracking using the tracking camera 300 in comparison with a configuration in which the filtering process is not performed.

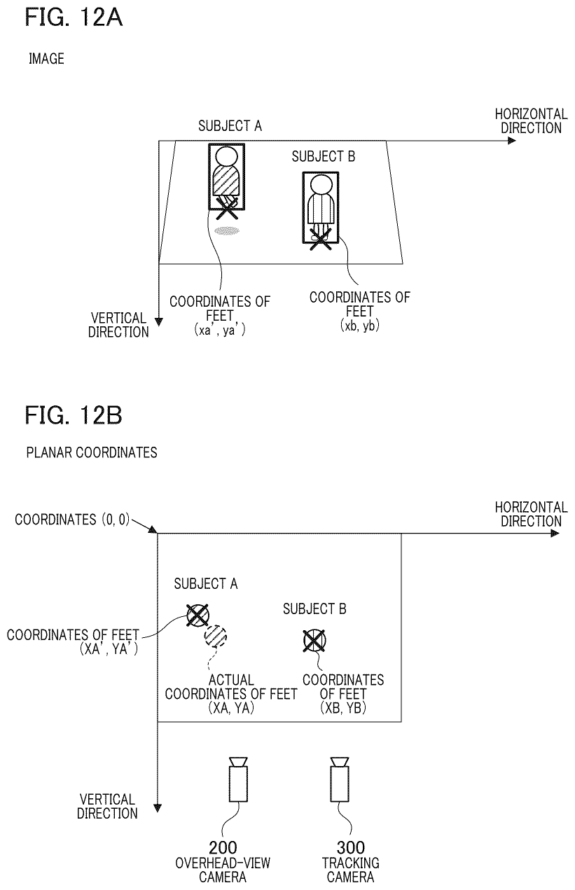

FIGS. 12A and 12B are diagrams illustrating an example in which a subject adopts a predetermined motion.

For example, it is assumed that subject A jumps in the vertical direction with respect to the floor surface from the state illustrated in FIG. 5A as illustrated in FIG. 12A. At this time, when an image is captured using the overhead-view camera 200, the subject detecting unit 121 of the control device 100 detects subject A which is jumping from the captured image. In this case, the subject detecting unit 121 detects coordinates (xa′, ya′) different from the coordinates (xa, ya) of subject A before jumping in the image coordinate system. The detected coordinates (xa′, ya′) are coordinates other than those before subject A jumps in the vertical direction in the image coordinate system.

The conversion unit 122 converts the coordinates (xa′, ya′) of subject A in the image coordinate system to coordinates (XA′, YA′) in the planar coordinate system as illustrated in FIG. 12B. In this case, the coordinates (xa′, ya′) in the image coordinate system are coordinates different in the vertical direction from those before subject A jumps, and the coordinates (XA′, YA′) in the planar coordinate system are also coordinates different from the coordinates (XA, YA) before subject A jumps. More specifically, the coordinates (XA′, YA′) in the planar coordinate system are coordinates different from the coordinates (XA, YA) before jumping in the optical axis direction of the overhead-view camera 200. Incidentally, the position in the planar coordinate system of subject A before and after jumping is the coordinates (XA, YA) and is identified as the coordinates (XA′, YA′) in the planar coordinate system by the conversion unit 122. When control is performed such that the tracking camera 300 tracks subject A on the basis of the assumption that subject A is located at the coordinates (XA′, YA′), an area different from the position of subject A may be to be tracked.

On the other hand, when the filtering process is performed on the coordinates (XA′, YA′) in the planar coordinate system converted by the conversion unit 122 as in the embodiment, the coordinates (XA′, YA′) in the planar coordinate system are corrected to a position close to the coordinates (XA, YA). Accordingly, the accuracy of tracking is enhanced as an influence of jumping of subject A on tracking using the tracking camera 300 decreases.

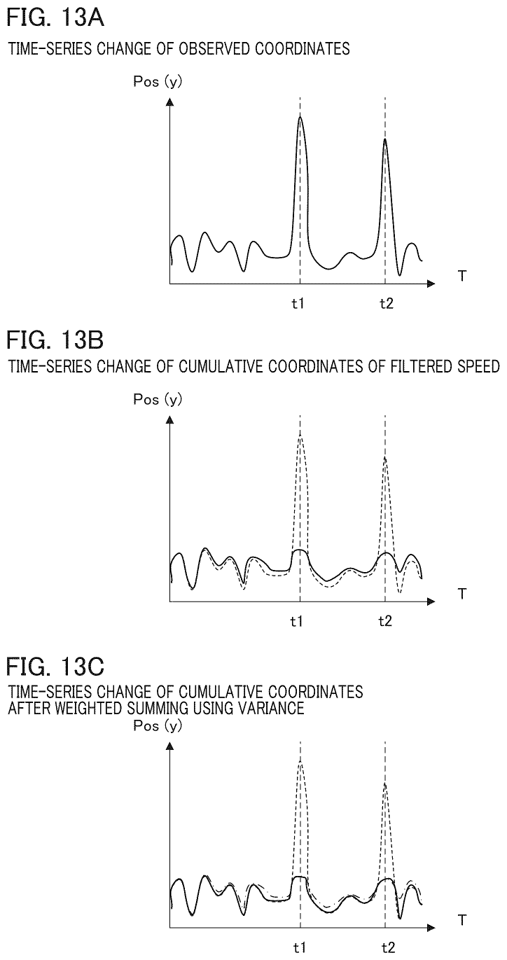

FIGS. 13A and 13C are diagrams illustrating a change in coordinates of a subject with the elapse of time. In FIGS. 13A and 13C, the horizontal axis represents time, and the vertical axis represents coordinates in the vertical direction in the planar coordinate system.

In FIG. 13A, a change in coordinates of the subject detected by the subject detecting unit 121 and converted by the conversion unit 122 is illustrated in a time series. Both time t1 and time t2 are times at which the subject jumps. As illustrated in FIG. 13A, when the subject is jumping, the coordinates in the vertical direction of the detected subject change greatly.

In FIG. 13B, a time-series change in coordinates in the vertical direction of the subject identified by the corrected coordinate information generated in Step 409 of the filtering process (see FIG. 10) is indicated by a solid line. In FIG. 13B, a time-series change of the coordinates illustrated in FIG. 13A is indicated by a dotted line. At time t1 and time t2 at which the subject jumps, the change in coordinates in the vertical direction of the subject identified by the corrected coordinate information is smaller than the change in coordinates illustrated in FIG. 13A. That is, an influence of jumping of the subject is reduced. On the other hand, when the subject does not jump, the coordinates of the subject identified by the corrected coordinate information is separated from the coordinates illustrated in FIG. 13A by considering the speed of the subject in Step 409 of the filtering process (see Equation 7).

In FIG. 13C, a time-series change in coordinates in the vertical direction of the subject identified by the corrected coordinate information generated in Step 411 of the filtering process is indicated by a solid line. The solid line illustrated in FIG. 13A is indicated by a dotted line in FIG. 13C. The solid line illustrated in FIG. 13B is indicated by an alternate long and short dashes line in FIG. 13C. At time t1 and time t2 at which the subject jumps, the change in coordinates in the vertical direction of the subject identified by the corrected coordinate information generated in Step 411 of the filtering process is smaller than the change in coordinates illustrated in FIG. 13A. When the subject does not jump, a separation between the coordinates in the vertical direction of the subject identified by the corrected coordinate information generated in Step 411 of the filtering process and the coordinates illustrated in FIG. 13A is small. This is because the corrected coordinate information is generated on the basis of the weighting coefficient coef calculated from the variance of the position of the subject (see Equation 7).

In this way, according to the embodiment, an influence of a predetermined motion or a predetermined posture such as jumping of the subject on the detection result of the position of the subject is reduced. When the subject does not adopt the predetermined motion or the predetermined posture, it is possible to curb the detection result of the position of the subject being separated from the actual position of the subject.

In the embodiment, the speed vector v is calculated as a speed in which components in both the vertical direction and the horizontal direction are combined, but the disclosure is not limited thereto.

The speed vector v may be calculated as a speed in one of the vertical direction and the horizontal direction. In this case, the filtered speed vector v′ may also be calculated as a speed in one of the vertical direction and the horizontal direction. For example, in one embodiment, the filter processing unit 123 removes a movement component in the vertical direction in the planar coordinate system by performing the filtering process on only the vertical direction when the subject moves greatly in the vertical direction in the planar coordinate system at the time of jumping. In this case, an influence of movement in the vertical direction of the subject is reduced, and an influence of movement in the horizontal direction such as a running motion is maintained. Details of the filtering process are not limited to the aforementioned example.

For example, the filter processing unit 123 may identify whether a motion of the subject is a predetermined motion on the basis of the trend of the change in position of the subject identified by a plurality of pieces of global coordinate information correlated with different pieces of time information and generate the corrected coordinate information on the basis of the identification result. The predetermined motion is, for example, a motion in which the subject temporarily moves greatly from planar coordinates and returns to the original coordinates such as jumping. A motion other than the predetermined motion is, for example, a motion in which the subject moves greatly from planar coordinates and does not return to the original coordinates such as a running motion.

Specifically, the filter processing unit 123 determines whether an interval between the time identified by the newest time information and the time identified by the time information stored in the coordinate management table is less than a predetermined time. The predetermined time is, for example, a time which is assumed to be necessary for a predetermined motion. When the time interval is less than the predetermined time, the filter processing unit 123 calculates a difference in a time series between the coordinates identified by the newest global coordinate information and the coordinates identified by the past global coordinate information. When the calculated difference includes a difference equal to or greater than a predetermined threshold value and the difference decreases with the elapse of time, the filter processing unit 123 replaces the global coordinate information in a period with the large difference with the newest global coordinate information. The filter processing unit 123 generates corrected coordinate information with an average value of the coordinates identified by the global coordinate information correlated with a time included in a predetermined period as corrected coordinates of the subject.

Through this process, a motion of temporarily moving greatly from planar coordinates and returning to the original coordinates such as jumping and a motion of moving realty and not returning to the original coordinates such as running are distinguished. In the motion such as jumping, an influence of a change in position during jumping on the detection result of the subject is reduced.

In the embodiment, the control device 100 performs the position identifying process (see FIG. 9B) on an image captured by the overhead-view camera 200, but the disclosure is not limited thereto. The position identifying process may be performed by the overhead-view camera 200 or may be performed by the tracking camera 300.

When the overhead-view camera 200 performs the position identifying process, the image captured by the overhead-view camera 200 is stored in the volatile memory 202 after the processes of Steps 101 and 102 of the overhead view imaging process (see FIG. 9A) have been performed. Thereafter, the processes of Step 202 and steps subsequent thereto in the position identifying process are performed.

When the tracking camera 300 performs the position identifying process, the processes of Steps 303 and 304 in the tracking process (see FIG. 9C) are performed after the processes of Steps 201 to 206 in the position identifying process have been performed.

The corrected coordinate information generated in Step 409 of the filtering process is not limited to the aforementioned example. The filter processing unit 123 may update the corrected coordinate information on the basis of the filtered speed vector v′ and the newest global coordinate information in Step 409 of the filtering process. This update of the corrected coordinate information is performed on the basis of Equation 10.

$$EXuEYu = XY + {v}^{′} \times ( T - Tm ) \qquad ( Equation 10 )$$

In Equation 10, XY is a vector of coordinates in the horizontal direction and coordinates in the vertical direction of the subject identified by the newest global coordinate information. That is, the newest global coordinate information may be used instead of the past corrected coordinate information.

As described above, in the embodiment, the filter processing unit 123 applies a filter to a subject position according to a moving speed of the subject position (see Steps 407 to 411 in FIG. 10).

In this case, in comparison with a configuration in which a subject position is identified without considering whether the motion or posture of the subject is a predetermined motion or a predetermined posture, it is possible to enhance the accuracy of the identified position of the subject adopting the predetermined motion or the predetermined posture.

The filter processing unit 123 corrects the subject position according to the past subject position and the moving speed and applies the filter to the subject position such that a degree of contribution of the moving speed on the correction of the subject position decreases as the moving speed increases (see Equation 5, Equation 6, and Equation 7).

In this case, it is possible to reduce an influence of temporary movement of the subject due to a high moving speed such as jumping on the detection result of the subject.

When the moving speed is less than a predetermined value, the filter processing unit 123 corrects the subject position according to the past subject position and the moving speed (see Equation 5, Equation 6, and Equation 7). A Fermi function u can be used as the predetermined value (see Equation 6). When the moving speed is equal to or greater than the predetermined value, the filter processing unit 123 applies the filter to the subject position such as the subject position is corrected such that the subject does not move from the past subject position.

In this case, it is possible to reduce an influence of temporary movement of the subject due to a high moving speed such as jumping on the detection result of the subject.

The filter processing unit 123 corrects the subject position according to the past subject position and the moving speed and limits correction of the subject position when there is no information indicating the past subject position in a predetermined period (see S405 in FIG. 10). The predetermined period is, for example, a period which is a threshold value used to determine whether to delete the global coordinate information, the time information, and the identification information in Step 403 of the filtering process (see FIG. 10). The predetermined period is, for example, a time interval which is a threshold value used to determine whether to delete the time information and the global coordinate information in Step 404 of the filtering process.

In this case, it is possible to curb correction of the subject position being performed with low accuracy when there is no information indicating the subject position.

The filter processing unit 123 calculates a variance of the subject position in a predetermined period, weighted-sums the subject position to which the filter has been applied and the subject position before correction according to the calculated variance, and corrects the subject position (see Steps 410 and 411 in FIG. 10).

In this case, in comparison with a configuration in which the subject position is corrected regardless of the variance of the subject position, it is possible to enhance the accuracy of an identified position of a subject not adopting a predetermined motion or a predetermined posture. In the embodiment, the filter is a filter based on the Fermi function.

In this case, it is possible to reduce an influence of movement of a subject on the detection result of the subject when the moving speed of the subject is equal to or greater than a predetermined value.

In the embodiment, the filter is a filter based on the sigmoid function.

In this case, it is possible to reduce an influence of movement of a subject on the detection result of the subject when the moving speed of the subject is equal to or greater than a predetermined value.

In the embodiment, the filter is a filter based on the tanh function.

In this case, it is possible to reduce an influence of movement of a subject on the detection result of the subject when the moving speed of the subject is equal to or greater than a predetermined value.

In the embodiment, the overhead-view camera 200 captures an image. The tracking camera 300 captures an image in a state in which a subject is tracked on the basis of the subject position corrected by the filter processing unit 123.

In this case, in comparison with a case in which a position of a subject is identified without considering whether the motion or the posture of the subject is a predetermined motion or a predetermined posture, it is possible to enhance the accuracy of tracking using the tracking camera 300.

The image in which the subject position is detected by the subject detecting unit 121 is an image in which the subject is imaged by the overhead-view camera 200 located at a position more separated from the subject to be tracked by the tracking camera 300 than the tracking camera 300. The tracking camera 300 acquires information based on the subject position corrected by the filter processing unit 123 and captures an image in a state in which the subject is tracked on the basis of the acquired information. The information based on the subject position corrected by the filter processing unit 123 is, for example, a control command for controlling the tracking camera 300.

In this case, it is possible to realize tracking of a tracked subject appearing in an image captured by the overhead-view camera 200 using the tracking camera 300 located at a position closer to the tracked subject than the overhead-view camera 200.

The information acquired by the tracking camera 300 is information based on the subject position converted from the coordinate in the image to the global coordinates by the conversion unit 122.

In this case, it is possible to realize tracking using the tracking camera 300 even when the coordinates in the images captured by the overhead-view camera 200 and the tracking camera 300 are not the same.

The conversion unit 122 converts the coordinates in the image of the subject position to the global coordinates according to a relationship between the coordinates of a marker which global coordinates are predetermined and the global coordinates (see Equation 1 and FIGS. 4A and 4B).

In this case, it is possible to simply perform conversion from the coordinates in the image of the subject position to the global coordinates.

In the embodiment, the tracking camera 300 tracks a subject through a panning operation or a tilting operation, but the disclosure is not limited thereto. The tracking camera 300 may track a subject through a zooming operation. In other words, the tracking camera 300 captures an image in a state in which a subject is tracked through at least one of the panning operation, the tilting operation, and the zooming operation.

In this case, it is possible to realize tracking of a subject in a wide range.

The tracking target determining unit 124 determines a subject to be tracked using the tracking camera 300 on the basis of the subject position corrected by the filter processing unit 123.

In this case, in comparison with a case in which a subject to be tracked is determined on the basis of the pre-correction subject position, it is possible to curb the subject to be tracked being erroneously determined.

The subject detecting unit 121 and the filter processing unit 123 decrease the weight of the position of the subject at the time of adopting a predetermined motion or a predetermined posture and determine the position of the subject.

In this case, in comparison with a case in which a position of a subject is identified without considering whether the motion or the posture of the subject is a predetermined motion or a predetermined posture, it is possible to enhance the accuracy of the identified position of the subject adopting the predetermined motion and the predetermined posture.

### Other Embodiment

The disclosure can also be realized by a process of supplying a program for realizing one or more functions in the embodiment to a system or a device via a network or a storage medium and causing one or more processors in a computer of the system or device to read and execute the program. The disclosure can also be realized by a circuit (for example, ASIC) for realizing one or more functions.

While the disclosure has been described above in detail in conjunction with exemplary embodiments, the disclosure is not limited to the embodiments, and various modifications thereof can be realized on the basis of the gist of the disclosure and are not intended to exclude from the scope of the disclosure.

According to the disclosure, it is possible to enhance accuracy of an identified position of a subject adopting a predetermined motion or a predetermined posture in comparison with a configuration in which the position of the subject is identified without considering whether the motion or the posture of the subject is the predetermined motion or the predetermined posture.

An embodiment of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment and/or that includes one or more circuits (e.g., application specific integrated circuit (ASIC)) for performing the functions of one or more of the above-described embodiment, and by a method performed by the computer of the system or apparatus by, for example, reading out and executing the computer executable instructions from the storage medium to perform the functions of one or more of the above-described embodiment and/or controlling the one or more circuits to perform the functions of one or more of the above-described embodiment. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-051212, filed Mar. 26, 2025, which is hereby incorporated by reference herein in its entirety.

What is claimed is:

1. A system comprising an imaging device and a processing device,
wherein the processing device includes:
at least one memory storing instructions; and
at least one processor executing the stored instructions causing the processing device to:
detect a subject position in an image captured by the imaging device from the image;
convert the detected subject position in the image to a subject position in a global coordinate system;
correct the converted subject position; and
apply a filter to the subject position according to a moving speed of the subject position.

2. The system according to claim 1, wherein executing the stored instructions by the processor further causes the processing device to:
correct the subject position according to the subject position in the past and the moving speed; and
apply the filter to the subject position such that contribution of the moving speed to the correcting the subject position decreases as the moving speed increases.

3. The system according to claim 1, wherein executing the stored instructions by the processor further causes the processing device to:
correct the subject position according to the subject position in the past and the moving speed when the moving speed is less than a predetermined value; and
apply the filter to the subject position such that the subject position is corrected as a subject having not moved from the subject position in the past when the moving speed is equal to or greater than the predetermined value.

4. The system according to claim 1, wherein executing the stored instructions by the processor further causes the processing device to:
correct the subject position according to the subject position in the past and the moving speed; and
limiting the correcting the subject position when there is no information indicating the subject position in the past in a predetermined period.

5. The system according to claim 1, wherein executing the stored instructions by the processor further causes the processing device to:
calculate a variance of the subject position in a predetermined period; and
correct the subject position by weighted-summing the subject position to which the filter has been applied and the subject position before corrected according to the calculated variance.

6. The system according to claim 1, wherein the filter is a filter based on a Fermi function.

7. The system according to claim 1, wherein the filter is a filter based on a sigmoid function.

8. The system according to claim 1, wherein the filter is a filter based on a hyperbolic tangent function.

9. The system according to claim 1, wherein the imaging device includes a first imaging device capturing the image and a second imaging device, and
wherein the second imaging device captures an image in a state in which a subject is tracked based on the corrected subject position.

10. The system according to claim 1, wherein the imaging device includes a first imaging device capturing the image and a second imaging device,
wherein the image in which the subject position has been detected is an image in which a subject is captured by the first imaging device farther separated from the subject to be tracked by the second imaging device than the second imaging device, and
wherein the second imaging device acquires information based on the corrected subject position and captures an image in a state in which the subject is tracked based on the acquired information.

11. The system according to claim 10, wherein the information acquired by the second imaging device is information based on the subject position in the global coordinate system converted from the subject position in the image.

12. The system according to claim 11, wherein executing the stored instructions by the processor further causes the processing device to convert the subject position in the image to the subject position in the global coordinate system according to a relationship between coordinates of a predetermined marker in the image and coordinates in the global coordinate system.

13. The system according to claim 9, wherein the second imaging device captures an image in a state in which the subject is tracked using at least one of a panning operation, a tilting operation, and a zooming operation.

14. The system according to claim 9, wherein executing the stored instructions by the processor further causes the processing device to determine the subject to be tracked by the second imaging device based on the corrected subject position.

15. A processing device comprising:
at least one memory storing instructions; and
at least one processor executing the stored instructions causing the processing device to:
acquire feature information of a subject from an image captured by an imaging device;
determine a position of the subject from a part at which the subject is grounded based on the feature information;
identify a position when the subject is seen from above based on the determined position; and determine the position of the subject by decreasing a weight of a position of the subject when the subject adopts a predetermined motion or a predetermined posture.

16. A method of a system including an imaging device and a processing device, the method comprising:
detecting a subject position in an image captured by the imaging device from the image;
converting the detected subject position in the image to a subject position in a global coordinate system; and
correcting the converted subject position,
wherein the correcting the subject position is performed by applying a filter to the subject position according to a moving speed of the subject position.

17. A method of a processing device, the method comprising:
acquiring feature information of a subject from an image captured by an imaging device;
determining a position of the subject from a part at which the subject is grounded based on the feature information; and
identifying a position when the subject is seen from above based on the determined position,
wherein the determining the position of the subject by decreasing a weight of a position of the subject when the subject adopts a predetermined motion or a predetermined posture.

18. A non-transitory storage medium storing a program of a system comprising an imaging device and a processing device causing a computer to perform a method, the method comprising:
detecting a subject position in an image captured by the imaging device from the image;
converting the detected subject position in the image to a subject position in a global coordinate system; and
correcting the converted subject position,
wherein the correcting the subject position is performed by applying a filter to the subject position according to a moving speed of the subject position.

19. A non-transitory storage medium storing a program of a processing device causing a computer to perform a method of the processing device, the method comprising:
acquiring feature information of a subject from an image captured by an imaging device;
determining a position of the subject from a part at which the subject is grounded based on the feature information; and
identifying a position when the subject is seen from above based on the determined position,
wherein the determining the position of the subject by decreasing a weight of a position of the subject when the subject adopts a predetermined motion or a predetermined posture.
